(19) United States
(12) Patent Application Publication
(10) Pub. No.: US 2014/0124432 A1
(43) Pub. Date: May 8, 2014

(54) WATER TREATMENT FILTERING EQUIPMENT WITH EASY REMOVING OF FOREIGN MATTER

(71) Applicant: CYGNUSPOWER CO., LTD., Gwangju-si (KR)

(72) Inventor: Yang-Il YOON, Gwangju-si (KR)

(73) Assignee: CYGNUSPOWER CO., LTD., Gwangju-si (KR)

(21) Appl. No.: 13/705,405

(22) Filed: Dec. 5, 2012

(30) Foreign Application Priority Data
Nov. 6, 2012 (KR) 10-2012-0124803

(51) Int. Cl. B01D 29/00

(52) U.S. Cl. CPC B01D 29/0077
USPC 210/355

(57) ABSTRACT

This invention is on water treatment filtering equipment which supplies water after removing foreign matter included in original water such as underground water. To be more particular, the water treatment filtering equipment according to this invention has a filter installed in the inside of the housing and a blade which automatically rotates by the pressure of the inflown original water installed in the outside of said filter so that said blade may drop and remove foreign matter while rotating when original water passes through said filter.

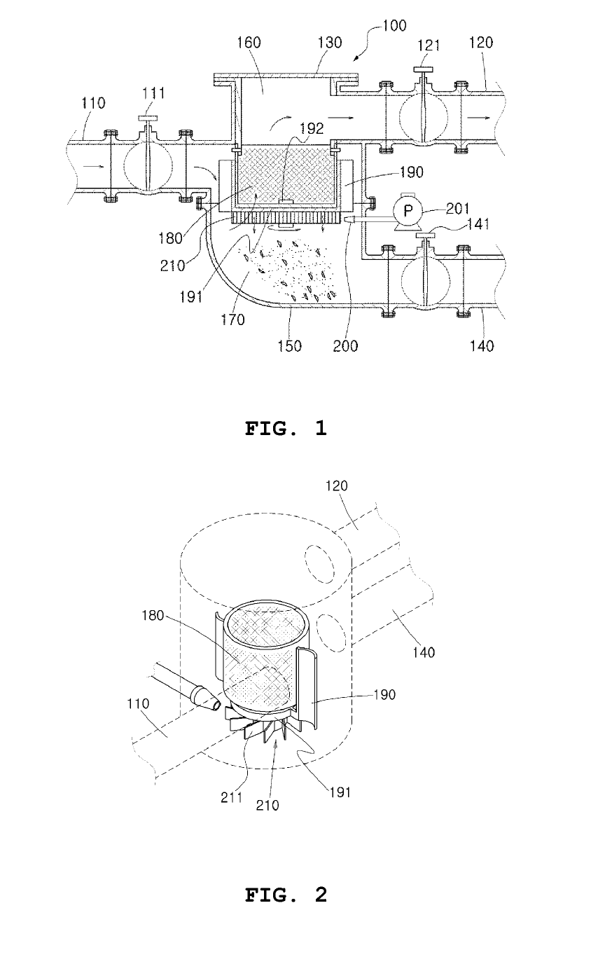

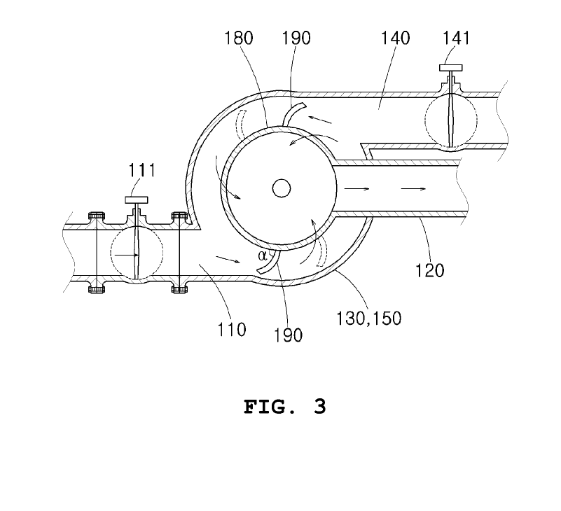

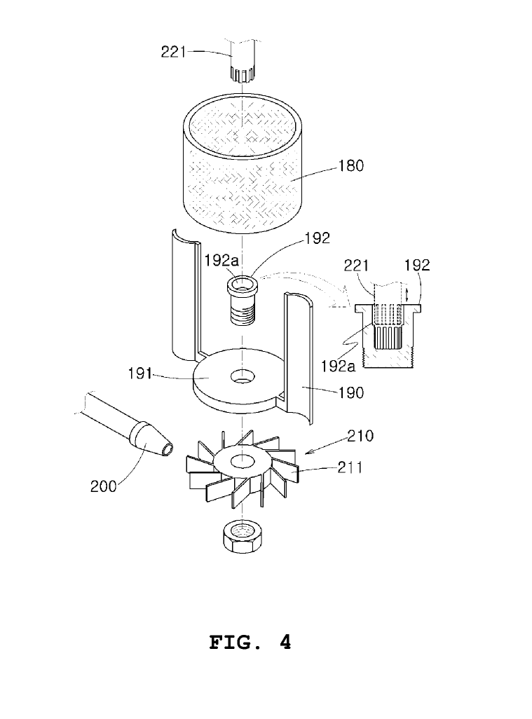

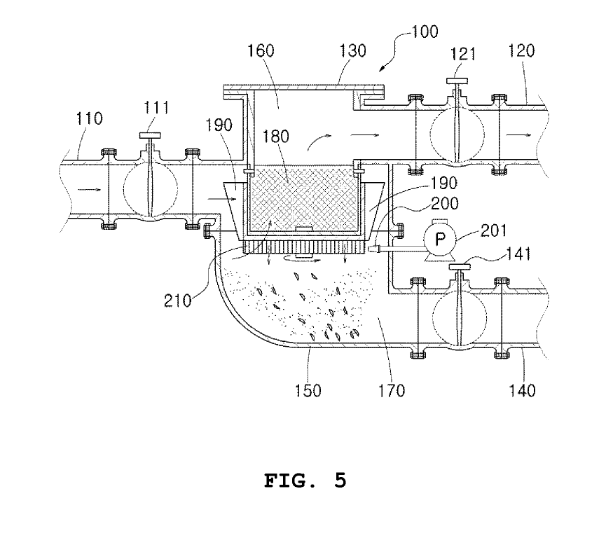

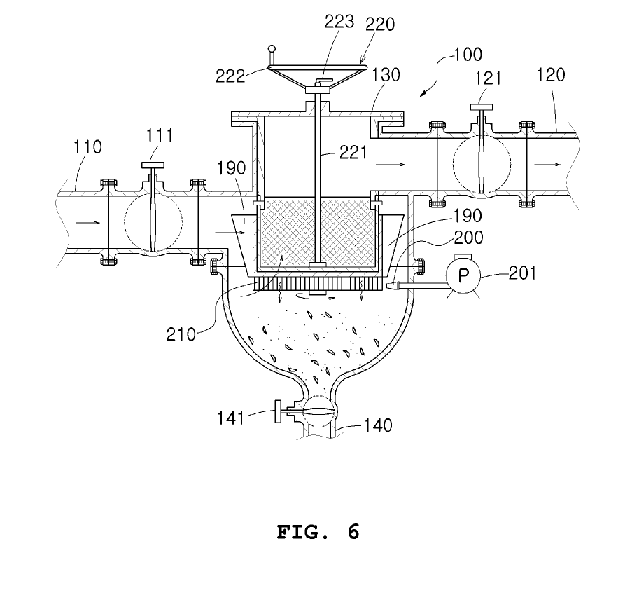

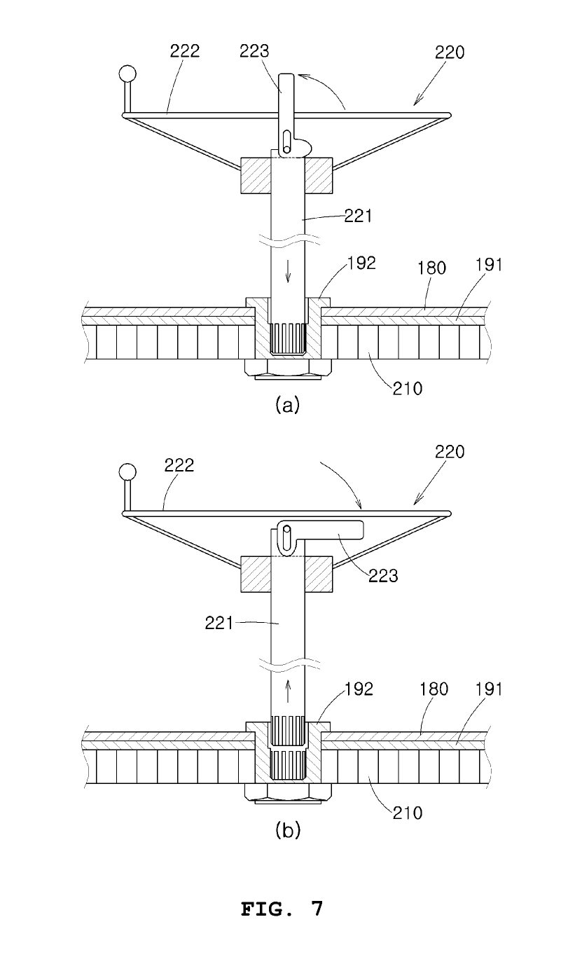

### FIELD OF THE INVENTION

This invention is on water treatment filtering equipment which supplies water after removing foreign matter included in original water such as underground water. To be more particular, the water treatment filtering equipment according to this invention has a filter installed in the inside of the housing and a blade which automatically rotates by the pressure of the inflown original water installed in the outside of said filter so that said blade may drop and remove foreign matter while rotating when the original water passes through said filter.

### DESCRIPTION OF RELATED ART

Recently, demand for water is soaring with rapid industrialization and population growth, while the lack of agricultural irrigation water is getting worse with the exhaustion of water resource and extreme water pollution in some areas. Some areas make a great effort to solve water shortage in public waters such as enforcement of restrictive water rationing and other areas proceed with tubular well construction to search for a vein of water so as to supply agricultural irrigation water.

Like this, irrigation water obtained by tubular well construction is supplied to horticultural houses, landscaping, and pomicultural and floriculturual farms for growing crops. At this time, because irrigation water contains a good deal of foreign matters and sediments, such water is not directly supplied to crops but filtered through filtering equipment. The examples of such filtering equipment include cyclonal system with installation of wire mesh, perforated panel, slit plate, and screen, centrifugal system, and filtering system.

The biggest problem of the abovementioned filtering equipment is that if such screen, filter, and perforated panel are clogged or contaminated by foreign matters such as sediments, they can not carry out the filtering function.

In order to solve such a problem, the conventional ways to discharge foreign matter from filtering equipment such as filter, screen and perforated panel including sweeping away, scrapping or back washing filtering member were suggested. Meanwhile, for filtering equipment, agricultural water filter is announced in Korea Utility Model Registration No. 104843 as a way to remove foreign matter without a need to disassembe a filter.

In the abovementioned agricultural water filter, the body and the cap of the filter are combined by a band and the top and the front of the container are connected to water supply pipe and discharge pipe. In the side wall of the bottom of said filter body, inclined projected part is installed and filth collecting room is installed in the inside of the part and filth discharge pipe is installed in front of said filth collecting room.

In order to remedy the abovementioned problems, agricultural circular water filter is noticed in Utility Model Registration No. 262908, which removes foreign matter by generating eddy upon filtering underground water.

This kind of water filter is in structure which makes processed water inflown through original water incurrent pipe flow along the face of filter whereby foreign matter is removed. In Japanese Open Patent No. 2001-46816, a filtering equipment to remove foreign matter from fluid is posted. The posted filtering equipment lifts a screen while separating foreign matter from the face of screen and discharges the separated foreign matter through the bottom of the container.

However, because this kind of filtering equipment has a structure which lifts a screen and removes foreign matter from the face of screen, it can not remove foreign matter from the screen in the process of filtering fluid. In particular, upon the lifting of filter, foreign matter is sticked between the filter face and the container and fixed.

### LEADING TECHNICAL LITERATURE

### Patent Literature

### (Patent Literature 1) KR 20-0104843 (Registration No.) 1997 Apr. 15.

### (Patent Literature 2) KR 20-0262908 (Registration No.) 2002 Jan. 18.

### (Patent Literature 3) KR 20-0326890 (Registration No.) 2003 Sep. 4.

### DESCRIPTION OF THE INVENTION

### Tasks to be Solved

Although the abovementioned agricultural water filter can discharge solid foreign matter which is filtered through the filter and accumulated in filth collecting roomthrough filth discharge pipe by water pressure, said filth discharge pipe is formed perpendicular to the direction of discharging water, which makes it hard to have the denite effect of removing foreign matter.

Also, agricultural circular water filter has problem that processed water should flow at a certain speed so that foreign matter in the filter may be removed. And, the conventional filtering equipment has disadvantages including complicated configuration, high installation cost, low economic feasibility, and difficult maintenance and repair.

This invention is conceived to solve the abovementioned problems.

The water treatment filtering equipment of this invention has a rotary blade which rotates automatically by the pressure of water inflown toward the outside of filter, a rotary gear which rotates by the high-pressure jet force of nozzle and a manual rotary tool which makes the rotary blade and the rotary gear rotate by force using a removable rotary shaft. In the early inflow of water, foreign matter in the filter is dropped by the rotary blade. When the rotary power of said rotary blade is weakened, said rotary gear and said manual rotary tool are turned sequentially to increase the rotary power of said rotary blade so as to effectively remove foreign matter from the filter. The purpose of this invention is to improve the durability of filtering equipment remarkably as well as remove foreign matter easily so that filtering function may be maintained continuously.

Another purpose of this invention is to generate eddy by adjusting the thickness of rotary blade installed in the filter so that the separated foreign matter from the filter may drop easily toward the bottom and filtering efficiency be improved.

### Tools to Solve Tasks

For water treatment filtering equipment with easy removing foreign matter contained in original water, this invention which aims to attain the abovementioned purpose is characterized as consisting of upper housing which consists of original water supply pipe through whith foreign matter containing water is supplied is connected and installed in one side and purified water discharge pipe through which filtered water without foreign matter is discharged is connected in the other side, lower housing which is installed in the bottom of said uppoer housing and has mixed water discharge pipe which discharges mixed water containing removed foreign matter connected and installed in one side, cylindrical filter which is installed in the inside of said upper housing and said lower housing and forms upper space part connected to said purified water discharge pipe with inflow of purifed water without foreign matter and lower space part connected to said mixed water discharge pipe with storage of mixed water including separated foreign matter, and rotary blade which is installed on the face of said filter so as to scrape and drop foreign matter from the face of said filter while rotating by the pressure of inflown original water.

### Effect of the Invention

The water treatment filtering equipment with easy removing of foreign matter of this invention can remove easily foreign matter from the filter and improve remarkably the durability of filter as well as maintain the function of filtering continuously and is convenient to maintain and manage.

Also, the filtering equipment of this invention can remove foreign matter in filter automatically and improve filtering efficiency of fluid and discharge foreign matter separated from filter easily using eddy of the fluid inflown to the inside of filter. In addition, the filtering equipment of this invention can reduce waste of original water remarkably by increasing interval of discharging mixed water with improved efficiency of filter.

### BRIEF DESCRIPTION OF THE SEVERAL VIEW OF THE DRAWING

Drawing 1 is the constitutional sectional view of the water treatment filtering equipment with easy removing of foreign matter of this invention.

Drawing 2 is the constitutional schematic which shows the rotary blade installed in the water treatment filtering equipment with easy removing of foreign matter of this invention rotates by water pressure.

Drawing 3 is the consitutional top view of the drawing 2.

Drawing 4 is the constitutional schematic which shows the middle part is separated from the water treatment filtering equipment with easy removing of foreign matter of this invention.

Drawing 5 is the consitutional schematic which shows another embodiment of the water treatment filtering equipment with easy removing of foreign matter of this invention.

Drawing 6 is the consitutional schematic which shows manual rotary tool is attached to the water treatment filtering equipment with easy removing of foreign matter of this invention.

Drawing 7 is the consitutional sectioinal view which shows the manual rotary tool installed in the water treatment filtering equipment with easy removing of foreign matter of this invention is removable.

### DESCRIPTION OF THE USE OF INVENTION

From now on, description is followed so that those who have common knowledge in relevant field may use this invention easily in reference with the drawings of desirable embodiment of this invention.

As shown in drawings 1 through 3, the water treatment filtering equipment with easy removing of foreign matter of this invention (100) consists of

Upper housing (130) in which original water supply pipe (110) through which underground water containing foreign water pumped from underground through tubular well (“original water”) is connected and installed in one side and purified water discharge pipe (120) through which purified water after filtering and removing foreign matter is discharged in the other side,

Lower housing (150) which is installed in the lower part of said upper housing (130) and has mixed water discharge pipe (140) through which mixed water containing removed foreign matter is discharged connected and installed in one side,

Cylindrical filter (180) which is installed in the inside of said upper housing (130) and said lower housing (150) and forms upper space part (160) connected to said purified water discharge pipe (120) with inflown purified water without foreign matter in the upper part and lower space part (170) connected to said mixed water discharge pipe (140) with stored mixed water containing removed foreign matter,

Rotary blade (190) which is installed on the face of said filter (180) and rotates by the pressure of original water inflown and scrapes and drops foreign matter from said filter (180), and

Rotary gear (210) which is connected to said rotary blade (190) and is equipped in the lower part of said filter (180) so as to increase the rotary power of said rotary blade (190) rotating by the jet force of jet nozzle (200).

The mechanism of the water treatment filtering equipment with easy removing of foreign matter (100) configured as abovementioned is that said rotary blade (190) rotates by the pressure of original water inflown through said original water supply pipe (110) and by the rotary power, one side of said rotary blade (190) can scrape and drop foreign matter from the face of said filter (180).

Therefore original water inflown through said original water supply pipe (110) is filtered and foreign matter contained in the original water can be removed automatically by said rotary blade (190).

At this time, blade connecting part (191) which connects several said rotary blades (190) at the end of them and rotate them is installed in the lower part of said filter (180) so as to rotate by rotary shaft (192).

Therefore, when external force (supply pressure of original water) is given to said rotary blade (190), said blade connecting part (191) can rotate by said rotary shaft (192), which makes said rotary blade (190) rotate along the face of said filter (180) and drop and remove foreign matter from the surface of said filter (180).

Also, in the bottom of said blade connecting part (191), said cylindrical rotary gear (210) which generates the rotary power by the jet force of said jet nozzle (200) is connected and fixed.

And said cylindrical rotary gear (210) is connected to the bottom of said blade connecting part (191) and fixed and on the face, many speed cones (211) are formed and equipped at a regular interval.

Also, said jet nozzle (200) is to be connected to jet pump (201) which pumps water from water storage part (not shown).

Therefore, when water is injected from said jet nozzle (200) through said jet pump (201), the jet force is applied to said speed cone (211) equipped on said rotary gea (210) and said rotary gear (210) rotates around said rotary shaft (192).

At this time, said rotary gear (210) is fixed with said blade connecting part (191) and both are always turning together.

That is, said rotary shaft (192) is installed in the lower center of said filter (180) so as to rotate and said rotary shaft (192) is installed so that said rotary gear (210) and said blade connecting part (191) may rotate simultaneously.

And as shown in drawings 2 and 3, it is desirable to form said rotary blade (190) to have a bent surface so as to receive the inflown pressure to the maximum and install it to form a sharp angle (a) with said filter (180). That is, said rotary blade (190) should be installed so that the surface pressed by water may be formed concavely.

Also, it is desirable to install said original water supply pipe (110) in the side of housing so that the pressure of original water inflown may be directly applied to said rotary blade (190).

Therefore, original water inflown through said original water supply pipe (110) forms eddy while inflowing into the side of said filter (180) and this eddy makes said rotary blade (190) rotate.

And said original water supply pipe (110) has original water supply valve (111) which makes original water inflow equipped and said purified water discharge pipe (120) has purified water supply valve (121) which supplies purified water with foreign matter filtered, and said mixed discharge pipe (14) has mixed discharge valve (141) which discharges water mixed with foreign matter to the outside. And said mixed discharge pipe (140) may be installed either the side or the bommon of said lower housing (150).

Also, said upper housing (130) and said lower housing (150) have pressure sensor (not shown) which can measure the pressure of fluid in them. Therefore, depending on the difference value between said pressure sensor, said mixed water discharge pipe (140) opens or is closed so as to discharge foreign mattter to the outside.

With this configuration of pressure sensor, the control part can ring buzzer when the difference between both pressure values is higher than a certain value or automatically open said mixed water discharge pipe (141) equipped in said mixed water discharge pipe (140).

And, as shown in drawing 5, said rotary blade (190) may form the width smaller from the top to the bottom. It makes the pressure of original water inflown by the rotation of said rotary blade (190) different between the upper part and lower part of said rotary blade (190) so that foreign matter dropped from the upper part of said filter (180) may go down towards the lower part easily.

And, if it is hard to remove foreign matter filtered by said filter (180) by rotation of said rotary blade (190) and said rotary gear (210) (including such case that many foreign matters are fallen in mixed water in said lower space part (170) formed in said lower housing (150) and many foreign matters are fixed on the surface of said filter (180)), as shown in drawings 6 and 7, manual rotary tool (220) can be more installed on the top of said upper housing (130) so that said rotary blade (190) and said rotary gear (210) may be forcibly turned by external force.

At this time, said manual rotary tool (220) consists of central rotary shaft (221) of which lower part can be attached or detached to/from said rotary shaft (192) by penetrating the center of said filter (180) and working handle (222) which is equipped on the top of central rotary shaft (221) to make it rotate.

And, said rotary shaft (192) has shaft hole (192a) into which the lower part of said central rotary shaft (221) may be inserted and fixed, and in the internal bottom of said shaft hole (192a), female spline (so called boss) is formed.

Also, in the lower part of said central rotary shaft (221), a spline inserted into said shaft hole (192a) is formed.

And in the center of said working handle (222), working lever (223) which is connected to the top of said central rotary shaft (221) so as to slide it up and down is equipped.

Therefore, when said working lever (223) is pushed to one side, the bottom of said central rotary shaft (221) is inserted into said shaft hole (192a) and said rotary shaft (192) and said central rotary shaft (221) are fixed, and if said working handle (22) is turned, said roatry blade (190) and said rotary gear (210) can rotate by force (see drawing 7a).

And if said working lever (223) is pulled in opposite directions, the bottom of said central rotary shaft (221) are sticked out of said shaft hole (192a) and the connecting status of said rotary shaft (192) and said central rotary shaft (221) is released (see drawing 7b).

At this time, the connecting structure of said working level (223) can be many slit grooves as shown in drawing 7b or embodied easily according to a variety of corresponding technology, so detailed description will be omitted.

The water treatment filtering equipment with easy removing of foreign matter (100) configured as abovementioned can be installed and configured with control part (not shown) in which said original water supply valve (111), said purified water supply valve (121), said mixed water discharge valve (141), said jet pump (201) and said pressure sensor are connected, so as to operate them automatically by said control part.

As this configuration of control part can be usually embodied by engineer of relevant field, detailed description of the detailed connecting configuration will be omitted.

The procedure to operate water treatment filtering equipment with easy removing of foreign matter (100) is explained as follows.

First, open said original water supply valve (111).

Then, original water containing foreign matter is inflown through said original water supply pipe (110) along the side of said filter (180) and pushes said rotary blade (190).

At this time, rotary blade (190) rotates around said rotary shaft (192), while the side of said rotary blade (190) scrapes the face of said filter (180).

At this time, original water is filtered while foreign matter attached to the face of said filter (180) is removed and fallen.

At the same time, original water is filtered through said filter (180) and supplied to said upper space part (160) formed in said upper housing (130) and them supplied to relevant area through said purified water discharge pipe (120). Of course, said purified supply valve (121) should open.

And foreign matter fallen by said rotary blade (190) suspends in said lower space part (170) and if the volume of foreign matter increases, the pressure of mixed water increases and the rotary power of said rotary blade (190) becomes weak and decreases. At this time, run said jet pump (201) and shoot water out to speed cone (211) of said rotary gear (210) through said jet nozzle (200).

Then said rotary gear (210) rotates by jet force of said jet nozzle (200) and the rotary power of said rotary blade (190) increases by the rotary power of said rotary gear (210). And, as abovementioned, said rotary blade (190) and said rotary gear (210) are run together so as to keep the filtering function of said filter (180).

At this time, if rotary power decreases even if said rotary gear (210) rotates by use of said jet nozzle (200), run said working lever (223) installed in said rotary tool (220) to connect said central rotary shaft (222) to said rotary shaft (192). After that, when rotating said working handle (222) forcibly, said rotary blade (190) rotates and removes foreign matter.

But if the pressure of mixed water in said lower space part (170) keeps going high even after said rotary blade (190), said rotary gear (210) and said working handle (222) rotate together, open said mixed discharge valve (141) and discharge mixed water containing foreign matter by force through said mixed water discharge pipe (140). In this case, said purified water supply valve (121) should be closed.

And working procedure as mentioned above may be configured so as to be run automatically by configuring control part separately.

Like this, the water treatment filtering equipment with easy removing of foreign matter according to this invention has rotary blade which can automatically rotate by the pressure of original water inflown to the outside of filter, rotary gear which rotates by high-pressure jet power of nozzle in the lower part, and manual rotary tool which makes rotary blade and rotary gear rotate forcibly using detachable central rotary shaft. In early phase where original water is inflown, foreign matter is dropped from filter by rotary blade, and if the rotary power of said rotary blade becomes weak, have said rotary gear and said manual rotary tool rotate sequentially to increaes the rotary power of said rotary blade so that foreign matter may be effectively removed from filter, which improves remarkably durability as well as filtering efficiency of filter by maintaining filtering function.

### Legend

100: Water treatment filtering equipment with easy removing of foreign matter
110: Original water supply pipe 111: Original water supply valve
120: Purified water discharge pipe 121: Purified water supply valve
130: Upper housing
140: Mixed water discharge pipe 141: Mixed water supply valve
150: Lower housing 160: Upper space part 170: Lower space part
180: Filter
190: Rotary blade 191: Rotary blade connecting part 192: Rotary shaft
200: Jet nozzle 201: Jet pump
210: Rotary gear 211: Speed cone
220: Manual rotary tool

What is claimed is:

1. The water treatment filtering equipment with easy removing of foreign matter contained in original water which consists of
Upper housing in which original water supply pipe through which original water containing foreign matter is connected and installed in one side and purified water discharge pipe through which purified water after filtering and removing foreign matter is discharged in the other side,
Lower housing which is installed in the lower part of said upper housing and has mixed water discharge pipe through which mixed water containing removed foreign matter is discharged connected and installed in one side,
Cylindrical filter which is installed in the inside of said upper housing and said lower housing and forms upper space part connected to said purified water discharge pipe with inflown purified water without foreign matter in the upper part and lower space part connected to said mixed water discharge pipe with stored mixed water containing removed foreign matter, and
Rotary blade which is installed on the face of said filter and rotates by the pressure of original water inflown and scrapes foreign matter and separates them from said filter.

2. The water treatment filtering equipment with easy removing of foreign matter as claim 1, wherein rotary shaft is inserted and installed in the lower center of said filter and blade connecting part is equipped in said rotary shaft so as to connect and rotate said rotary blade.

3. The water treatment filtering equipment with easy removing of foreign matter as claim 2, wherein rotary gear which have many speed cones installed at a regular interval is installed on the face so as to increase the rotary power of said rotary blade connected and fixed in the bottom of said blade connecting part.

4. The water treatment filtering equipment with easy removing of foreign matter as claim 1, wherein said rotary blade has the surface pressed by water formed concavely and is installed on the face of said filter.

5. The water treatment filtering equipment with easy removing of foreign matter as claim 4, wherein said rotary blade is configured with smaller width from the top to the bottom.

6. The water treatment filtering equipment with easy removing of foreign matter as claim 1, wherein said rotary blade is installed on the face of said filter forming a sharp angle.

7. The water treatment filtering equipment with easy removing of foreign matter as claim 3, wherein manual rotary tool which make said rotary blade and said rotary gear forcibly rotate by external force is connected and installed in the upper part of said upper housing and said manual rotary tool consists of central rotary shaft of which lower part is inserted and installed in saif rotary shaft by penetrating the center of said filter and working handle which is installed in the upper part of said central rotary shaft to make it rotate.

8. The water treatment filtering equipment with easy removing of foreign matter as claim 7, wherein said central rotary shaft has many slit grooves so that the bottom may be attached or detached to and from said rotary shaft.
